(19) United States
(12) Patent Application Publication
(10) Pub. No.: US 2024/0292070 A1
(43) Pub. Date: Aug. 29, 2024

(54) ITERATIVE AI PROMPT OPTIMIZATION FOR VIDEO GENERATION

(71) Applicant: Loop Now Technologies, Inc., San Mateo, CA (US)

(72) Inventors: Wu-Hsi Li, Somerville, MA (US); Edwin Chiu, Cupertino, CA (US); Hong-Ming Tseng, Toronto (CA); Xiaochen Zhang, Shanghai (CN)

(73) Assignee: Loop Now Technologies, Inc., San Mateo, CA (US)

(21) Appl. No.: 18/631,287

(22) Filed: Apr. 10, 2024

Related U.S. Application Data
(63) Continuation-in-part of application No. 18/585,212, filed on Feb. 23, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/557,622, filed on Feb. 26, 2024.
(60) Provisional application No. 63/571,732, filed on Mar. 29, 2024.

(51) Int. Cl. H04N 21/81

(52) U.S. Cl. CPC H04N 21/816

(57) ABSTRACT

Disclosed embodiments provide techniques for iterative AI prompt optimization for video generation. A first text template to be read by a large language model (LLM) neural network is accessed. The template includes control parameters that are populated from within a website. The populated template is submitted as a request to the LLM neural network, which generates a first video script. The first video script is used to create a first short-form video. The first short-form video is evaluated based on one or more performance metrics. The text template, short-form video, website information, and evaluation are used to train a machine learning model that is used to create a second text template. The second text template can be used to generate a second short-form video. The evaluation of iterative text templates and resulting short-form videos continues until a usable video is produced.

### RELATED APPLICATIONS

This application claims the benefit of U.S. provisional patent applications “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, and “Artificial Intelligence Virtual Assistant Using Staged Large Language Models” Ser. No. 63/571,732, filed Mar. 29, 2024.

This application is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video generation and more particularly to iterative AI prompt optimization for video generation.

### BACKGROUND

Buying and selling goods and services is one of the oldest and most foundational aspects of human history and culture. Trade and commerce are essential to communication, transportation, and understanding of one another, and expand our ability to acquire and use resources beyond our own capacity to create or refine. Whole industries, networks, and technologies are dedicated to broadening our ability to exchange products and services with one another. The need to move products from one location to another fostered the development of trade routes and the design of vehicles to move raw materials to factories and finished goods to market. Storage and warehouse facilities have been built and adapted to allow for stockpiling of materials prior to manufacturing, and for the protection of completed goods prior to sale. Roads and bridges, railroad and shipping networks have been built to move goods from manufacturers to wholesalers, wholesalers to retailers, and retailers to consumers. Marketing and advertising strategies have been built and refined to communicate to businesses, governments, and consumers the details of products and services, encouraging them to purchase and make use of their wares. The insurance industry was invented in large part to alleviate the risks involved in all phases of commerce. Transportation, communication, security, and dangers from natural disasters are still common concerns that can be mitigated to some extent through the use of insurance policies and processes. Communications have been developed and enhanced on the basis of commercial requirements. Banking and financial institutions provide funding and aid in capitalizing expansion efforts.

As digital computer systems and data networks have expanded, many functions related to trade have developed alongside physical commercial activities, so that our opportunities to buy and sell are now global. Built upon successful methods of the past, ecommerce now amplifies and accelerates the rate at which business exchanges are made. Financial instruments and networks have been standardized, working through secure communications networks to purchase goods and services worldwide. Monetary exchange rates are established and, even though they fluctuate, the value of currencies can be quickly determined in a few seconds through federal or international services. Transportation networks quickly move finished goods directly to consumers or businesses in a few days, or in some cases, a few hours. Restaurants can transport meals to homes or offices in minutes using specialized delivery services. Computer applications are downloaded directly to computers and mobile devices in seconds. Purchases can be made with credit cards or a tap from a mobile phone.

While our technology has increased the speed at which business is conducted, the basic processes required to exchange goods and services have not changed. A medium of exchange is still required, with a mutually agreed upon value assigned to it by all parties. Whether the monetary medium is US dollars, gold, oil, or cryptocurrency, the relative value of the medium must be accepted by all parties and must be portable enough to allow easy and secure access. Storage and shipping of goods are still essential to the success of a vendor or the satisfaction of the consumer. And, despite all of our digital sophistication, human interaction is still required at many levels of ecommerce. From video meetings to livestream events, phone conference calls to texting, in the end, the human touch remains the best way to exchange goods and services among businesses, governments, and individuals.

### SUMMARY

Short-form videos and livestreams are now a vital means of communication in ecommerce marketing and sales. As more goods and services are offered through digital stores and networks, finding the best spokesperson and production values to represent products to potential buyers has become a critical component to successful marketing. Short-form videos and livestreams have become more sophisticated, more targeted, and more varied. At the same time, viewer audiences are becoming more selective in their choices of message content, means of delivery, and deliverers of messages. Ecommerce consumers can be persuaded to choose products or services based on recommendations from influencers on various social networks. This influence can take place via posts from influencers and tastemakers, as well as friends and other connections within the social media systems. Celebrities and product experts gather followers on social media platforms and can influence which products are purchased and how they are used. Sales representatives for various brands or vendors can also develop groups of buyers who are influenced to purchase products based on their demonstrations and recommendations. Just as a consumer might seek out a particular salesperson in a favorite department store, ecommerce consumers can log into social media outlets and internet platforms to purchase products from their chosen livestream host. The rising level of sophistication in video content and viewership is not limited to ecommerce. Education, political campaigns, government communication, and daily work team interactions are being impacted by the growing use of short-form videos. Popular educators, politicians, subject experts, and artists use short-form videos to broadcast and popularize their messages to an ever-increasing audience across the globe. All of these content generators continue to work to improve and refine their content and delivery in order to have the greatest impact on their viewing audience.

Disclosed embodiments provide techniques for iterative AI prompt optimization for video generation. A first text template to be read by a large language model (LLM) neural network is accessed. The template includes control parameters that are populated from within a website. The populated template is submitted as a request to the LLM neural network, which generates a first video script. The first video script is used to create a first short-form video. The first short-form video is evaluated based on one or more performance metrics. The text template, short-form video, website information, and evaluation are used to train a machine learning model that is used to create a second text template. The second text template can be used to generate a second short-form video. The evaluation of iterative text templates and resulting short-form videos continues until a usable video is produced.

A computer-implemented method for video generation is disclosed comprising: accessing a first text template, wherein the first text template is readable by a large language model (LLM) neural network, and wherein the first text template includes one or more control parameters; populating the first text template, wherein the populating includes information from within a website; submitting a request, to the LLM neural network, wherein the request includes the first text template that was populated; generating, by the LLM neural network, a first video script; creating a first short-form video, wherein the first short-form video is based on the first video script that was generated; evaluating the first short-form video, wherein the evaluating is based on one or more performance metrics; and creating a second text template based on the one or more performance metrics. Some embodiments comprise training a machine learning model, wherein a training data includes the first text template that was populated, the first short-form video that was created, the information from within the website, and the evaluating. In embodiments, the creating of the second text template is accomplished by the machine learning model. Some embodiments comprise removing, by the machine learning model, a control parameter from the one or more control parameters. Some embodiments comprise adding, by the machine learning model, a new control parameter. And some embodiments comprise including, by the machine learning model, at least one natural language instruction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for iterative AI prompt optimization for video generation.

FIG. 2 is a flow diagram for evaluating iterative AI prompt optimization in an ecommerce environment.

FIG. 3 is an infographic for iterative AI prompt optimization for video generation.

FIG. 4 is an infographic for updating a text template.

FIG. 5 is an infographic for evaluating a text template.

FIG. 6 illustrates an ecommerce purchase.

FIG. 7 is a system diagram for iterative AI prompt optimization for video generation.

### DETAILED DESCRIPTION

Short-form videos have become an essential part of marketing products and services to internet users across the globe. Beyond ecommerce, short-form video and image production are increasingly used in education, politics, art, and scientific endeavors. As digital image and audio processing technologies continue to expand and improve, the uses for short-form videos multiply. As short-form video uses have expanded, the sophistication of the audiences viewing the videos has grown as well. The ability to capture, edit, and manipulate image and audio recordings using inexpensive recording equipment or cell phones has resulted in a huge proliferation of video content and a growing sense of understanding and expertise among the general viewing population. The result is that viewer production values for short-form videos have become much more demanding. At the same time, viewer tastes have become more volatile. As social media platforms, news chats, texting, image, and video distribution have grown, the influences on various sectors of the population have become more fluid and easily altered. Messages, whether true or not, can be sent around the world in seconds, in the form of videos, texts, and sound bites. As a result, short-form video hosts, guests, products, and services can be popular one day and vilified the next. As one popular fashion reality show puts it, “One day you're in, the next day you're out”.

Techniques for video generation are disclosed. A text template, designed to be readable by a large language model (LLM)/generative AI chatbot, is accessed and populated with data from an ecommerce, education, or other type of website. The website information includes metadata about its users, including hashtags, purchase history, favorites, and so on. The metadata can include demographic information as well. Additional website information about products and services offered for sale, classes, enrollment requirements, ordering information, shipping details, education prerequisites, and so on can be specified. A group of control parameters is also included in the text template. The control parameters can be supplied from a library that can be updated and expanded as successful short-form videos are generated. The control parameters can specify the look and feel of the short-form video to be created, details on cameras and audio equipment to be used, settings to be used with the image and audio equipment, formats for the resulting videos, and so on. Host parameters can be detailed as well, including demographic specifications, social media engagement requirements, and so on.

Once the text template is populated with data from the website and control parameter library, it is fed to large language model (LLM) neural network which can be accessed through a generative artificial intelligence (AI) chatbot. The role of the AI chatbot is to translate the text template into a JavaScript Object Notation (JSON) video script that can be used to generate a short-form video. The LLM/AI chatbot has access to thousands of code libraries in multiple computer languages and can rapidly digest and generate data from a text template into the appropriate computer language. All of the website specifications and control parameters to be used in generating the short-form video are included in the video script. The resulting video script is fed into an AI machine learning model to generate a short-form video, including a synthetic host for the video based on the parameters included in the video script. Products to be demonstrated, class illustrations to be used, artistic styles to be referenced, and so on can all be specified as part of the video script and can be included in the resulting short-form video. Once the short-form video is produced, it is rendered to a website for viewers to watch and evaluate. In the case of ecommerce videos, an ecommerce environment including product cards, a virtual shopping cart, pricing, shipping information, and so on is rendered as part of the short-form video.

As the video plays, performance metrics are recorded and stored for evaluation purposes. Sales information, length of time watching videos, numbers of replays, likes, reposts, and so on are all captured and fed into the AI machine learning model. The performance metrics, video script, control parameters, website information, and the short-form video itself are all fed into the training side of the AI machine learning model and used to generate a second text script. The second text script includes changes to the control parameters and, in some cases, to the verbal script used by the synthetic video host. After the second text script is created, it is populated by the AI machine learning model and fed into the LLM/AI chatbot to create a second video script. The second video script is used to create a second short-form video including all of the updates and changes specified, and the second short-form video is rendered to a viewing audience. The audience responses are recorded and analyzed, the performance metrics and other details are fed into the AI machine learning model, and a third iteration of the short-form video production cycle can begin. The number of short-form video iterations can be specified in the video script, or the video generation iterations can be repeated until the performance metrics meet the desired level of engagement and sales. This process can be used to quickly generate effective short-form videos for multiple audiences with far less production cost than more conventional production methods. Furthermore, the videos can be stored and re-evaluated as viewer tastes and desires continue to evolve.

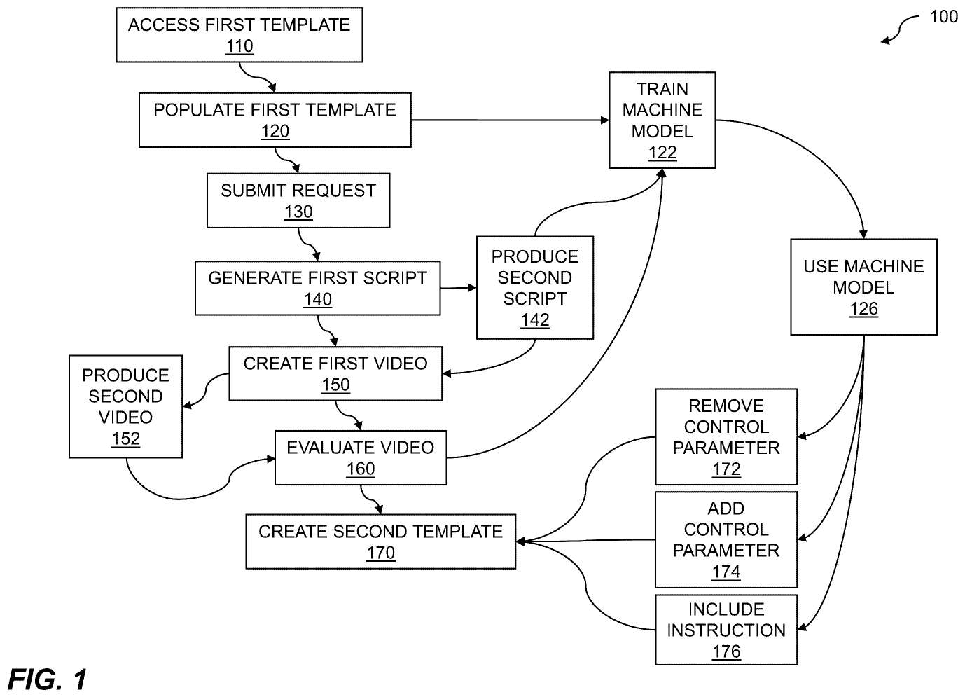

FIG. 1 is a flow diagram for iterative AI prompt optimization for video generation. The flow 100 includes accessing a first text template 110, wherein the first text template is readable by a large language model (LLM) neural network, and wherein the first text template includes one or more control parameters. A large language model is a type of machine learning model that can perform a variety of natural language (NLP) tasks, including generating and classifying text, answering questions in a human conversational manner, and translating text from one language to another. The machine learning model in an LLM neural network can include hundreds of billions of parameters. LLMs are trained with millions of text entries, including entire books, speeches, scripts, and so on. In embodiments, the LLM is a generative Artificial Intelligence (AI) chatbot. Generative artificial intelligence (AI) is a type of AI technology that can generate various types of content including text, images, audio, and synthetic data. The most recent versions of generative AI use generative adversarial networks (GANs) to create the content. A generative adversarial network uses samples of data, such as sentences and paragraphs of human-written text, as training data for a model. The training data is used to teach the model to recognize patterns and generate new examples based on the patterns. This first model is typically called a generator model. A second data model is built from real samples of data, such as additional sentences and paragraphs of text also written by humans in the desired form and style. This second model is called a discriminator model. Once the discriminator model has sufficient data available, its database is frozen. The generator model is then used to generate samples for the discriminator model to analyze. As each sample of generator data is fed into the discriminator, it makes a prediction as to whether the sample is fake or real. The predictions are used as the basis for adjustments to the generator model. A new sample is then generated by the generator model and is fed to the discriminator, which in turn makes a prediction that is used to adjust the generator. As the iterations of generator-discriminator-generator continue, the generator model learns to fool the discriminator. In other words, in our example, the text created by the generator model cannot be distinguished by the discriminator from similar types of text created by humans.

Creating GAN networks that are effective at generating human-like text, audio, and images requires large amounts of real data for the generator and discriminator models. In general, the more real data that can be fed into the models, the better the generator becomes at generating human-like language, sounds, and images. Recently, deep learning models called transformers have been developed that allow much larger amounts of data to be used. Transformers allow GAN language to take in and track the connections between words across pages, chapters, and whole books, rather than processing one sentence at a time. This allows billions of pages of text to be used in creating LLM/generative AI models to generate natural language processing (NLP) systems, photorealistic images and videos, language translators, and chatbots. The U.S. based company OpenAI has released an LLM/generative AI chatbot called ChatGPT™ that uses natural language processing to create human-like conversations and other interactions. It can be used to analyze and generate computer code with a high degree of efficiency and effectiveness; however, the form of the input is important in order to generate correct responses. Microsoft Corp. has made a major investment in ChatGPT and incorporated it into its Bing™ search engine. Google has a similar LLM/generative AI chatbot called Bard™, and several other companies are developing or have already released LLM/generative AI chatbot engines of their own.

In embodiments, a first text template created to be read by an LLM/generative AI chatbot such as ChatGPT is accessed and prepared for input from a website. The first text template includes one or more control parameters. The control parameters can include a tone or feel of a short-form video to be generated, such as positive or negative, serious or lighthearted, etc.; a target audience; video host characteristics such as gender, age, appearance, and vocal quality; video environment settings and background images; products for sale; media instructions; and so on. The one or more media instructions can include one or more cameras, a camera exposure, f-stop settings, video format, camera angles, lighting, language, voice-over text, a number of images, and a number of short-form videos to be created. In some embodiments, the one or more control parameters can be obtained from a library of templates. As the number of effective short-form videos increases, the most successful text templates can be stored in a database to be used with different combinations of products for sale, different audiences, and different host websites.

The flow 100 includes populating the first text template 120, wherein the populating includes information from within a website. In embodiments, the information from within a website can include one or more images, one or more videos, and text. The control parameters are taken from a website that is used for ecommerce and stores data relating to products for sale and customers that purchase goods and services. Metadata relating to the products for sale and to the customers can be included in the control parameter information and can be used to create a first short-form video. The first text template contains code language that can be read by the LLM/generative AI chatbot and placeholders for the information coming from the ecommerce website. The information from the ecommerce website is used to populate the first text template by placing the matching information into the placeholders contained in the first text template. The populated first text template is thus prepared to be submitted to the AI chatbot.

The flow 100 includes submitting a request 130, to the LLM/generative AI chatbot, wherein the request includes the first text template that was populated 120. In embodiments, after the information from the ecommerce website is used to populate the first text template, the text template is fed into the LLM/generative AI chatbot. The AI chatbot must be told the type of code required and the desired outputs of the code. These parameters are included in the first text template. If requested, the chatbot will break down and explain the resulting code it generates. The largest AI chatbots have access to hundreds of code libraries and coding resources created by programmers across the globe. In embodiments, the LLM/generative AI chatbot draws from these code libraries to construct programs in response to the request that includes the first text template. The flow 100 includes generating, by the LLM/generative AI chatbot, a first video script 140. In embodiments, the format of the first video script 140 generated is JavaScript Object Notation (JSON). The AI chatbot request 130 includes the JSON code format, as well as all of the first text template and control parameters from the ecommerce website. The response from the AI chatbot is a video script in JSON format that can be used to generate a short-form video. The video script 140 contains all of the control parameters and instructions necessary to generate the short-form video, including audio and video requirements, host information, product information, tone, number of short-form videos to be generated, and so on. The role of the LLM/generative AI chatbot is to translate the first text template into JSON code and write out a properly formatted video script using the JSON language.

The flow 100 includes creating a first short-form video 150, wherein the first short-form video is based on the first video script that was generated. In embodiments, the JSON formatted video script 140 can be used to create a first short-form video, including all of the control parameters from the first text template and the populated entries from the ecommerce website. The host of the short-form video can be a human host who matches the control parameters, or a synthetic AI generated host. The synthetic AI generated host can be created by combining a human host performance with a 3D photorealistic image of a host that matches the control parameters contained in the first video script. In some embodiments, the AI machine learning model can also generate the voice of the first video host. The first video host voice can be a human voice or a synthesized voice that better matches the control parameters contained in the first video script. The control parameters can include information about the audience for the first short-form video, based on metadata stored on the ecommerce website about its users. In some embodiments, the metadata can include images of the ecommerce website users. Images of the users can be combined with demographic, economic, and geographic information collected from the ecommerce website and included in the first video script. These parameters can be used as input to an artificial intelligence (AI) machine learning model. In embodiments, an AI machine learning model can be trained to recognize ethnicity, sex, and age.

The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters included in the video script. In some embodiments, one or more products for sale can be included in the video script. The first short-form video can include highlighting the one or more products by the human or synthetic video host.

The flow 100 includes evaluating the first short-form video 160, wherein the evaluating is based on one or more performance metrics. In embodiments, the evaluating comprises rendering, to one or more viewers, the first short-form video that was created, wherein the rendering includes an ecommerce environment. In some embodiments, the first short-form video can be used as a livestream hosted by the ecommerce website or a social media website. In embodiments, the first short-form video can include highlighting one or more products for sale to the one or more viewers, representing the one or more products for sale in an on-screen product card. The ecommerce environment includes enabling an ecommerce purchase, within the ecommerce environment, of one or more products for sale. The enabling the ecommerce purchase includes a virtual purchase cart, wherein the rendering further comprises displaying, within the first short-form video that was rendered, the virtual purchase cart. The virtual purchase cart can cover a portion of the first short-form video. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video.

In embodiments, the product card represents at least one product available for purchase on the website or social media platform hosting the short-form video, or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase by a user while preserving a short-form video session. In other words, the user is not redirected to another site or portal that causes the short-form video to stop. Thus, viewers can initiate and complete a purchase entirely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

In embodiments, the evaluating is accomplished by the machine learning model 126. The one or more performance metrics include an engagement metric, which can include a number of product sales, a number of views, a number of host followers, time spent on the host website, user metadata, and so on. The user metadata can include hashtags, purchase history, repost velocity, view attributes, view history, ranking, and actions by one or more viewers. The results of the evaluation can be used as input to a generative AI model in order to create a second text template. In later steps, the second text template can be used to generate a second video script 142, which in turn can be used to generate a second short-form video 152.

The flow 100 further comprises training a machine learning model 122, wherein the training data includes the first text template that was populated, the first short-form video that was created, the information from within a website, and the evaluating of the first short-form video. In embodiments, the training of the machine learning model is accomplished using a genetic algorithm. A genetic algorithm is an adaptive heuristic search algorithm that can be used to generate high-quality sets of options for solving optimization questions, such as finding the best set of control parameters to use in a video script in order to produce the most effective short-form video for engagement and product sales. In embodiments, a heuristic algorithm is used to generate solutions that are good enough to move forward in a reasonable time frame. They are essentially best guesses based on the available data that can be created quickly and used to create the next iteration of parameters for a generative AI model. The generative AI model can be trained with all the available information from the first iteration of short-form video generation, including the first text template, the data from the ecommerce website used to populate the template, the first short-form video, and the evaluation results.

The flow 100 includes creating a second text template 170 based on the one or more performance metrics. In embodiments, the creating the second text template 170 is accomplished by the machine learning model 126. After evaluating the performance of the first short-form video 160, the generative AI machine learning model can be used to generate a new set of control parameters. The creating the second text template can be accomplished by the machine learning model 126 by removing a control parameter 172 from the one or more control parameters, by adding a new control parameter 174, and by including at least one natural language instruction 176. The natural language (NLP) instruction can be used to change control parameters used in the second text template, such as modifying or expanding the spoken text of the video host, updating printed descriptions used in the next short-form video, etc. In some embodiments, the NLP instruction can modify the second text template directly, so that the video script created by the LLM/generative AI chatbot is updated and improved. After the second text template is created, it is populated by the machine learning model 126. After being populated, the second text template is included in a request to the LLM/generative AI chatbot to produce a second video script 142. The format of the second video script that was generated is JavaScript Object Notation (JSON). The second video script 142 is used to produce a second short-form video 152.

As with the first short-form video, the second short form video is evaluated by the machine learning model 126. The evaluating includes rendering, to one or more viewers, the first short-form video that was created, wherein the rendering includes an ecommerce environment. The ecommerce environment includes highlighting one or more products for sale to the one or more viewers and representing the one or more products for sale in an on-screen product card. The ecommerce environment includes enabling an ecommerce purchase, within the ecommerce environment, of one or more products for sale. The enabling the ecommerce purchase includes a virtual purchase cart, wherein the rendering further comprises displaying, within the first short-form video that was rendered, the virtual purchase cart. In embodiments, the virtual purchase cart covers a portion of the second short-form video. The one or more performance metrics include an engagement metric which can include a number of product sales, a number of views, a number of host followers, time spent on the host website, user metadata, and so on. The user metadata can include hashtags, purchase history, repost velocity, view attributes, view history, ranking, and actions by one or more viewers. In embodiments, the results of the performance metrics evaluation of the second short-form video can be combined with the populated second text template, and the second short-form video, to update the training data of the machine learning model 126. The updated machine learning model can then be used to create a third text template.

In embodiments, the flow 100 includes creating a third text template based on the one or more performance metrics. As with the second text template 170, creating the third text template is accomplished by the machine learning model 126. The cycle of creating a text template 170, populating the text template from the ecommerce website and the generative AI machine learning model 126, submitting the populated text template to the LLM/generative AI chatbot to create a video script 142, using the video script to produce a short-form video 152, and evaluating the short-form video can continue until the number of short-form videos indicated in the first text template 110 is reached, or the evaluation of the short-form video is of high enough quality to use with viewers. The text templates, short-form videos, website information, control parameters, and performance metrics from each iteration are submitted to the machine learning model in order to train the machine learning model to produce more effective short-form videos.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

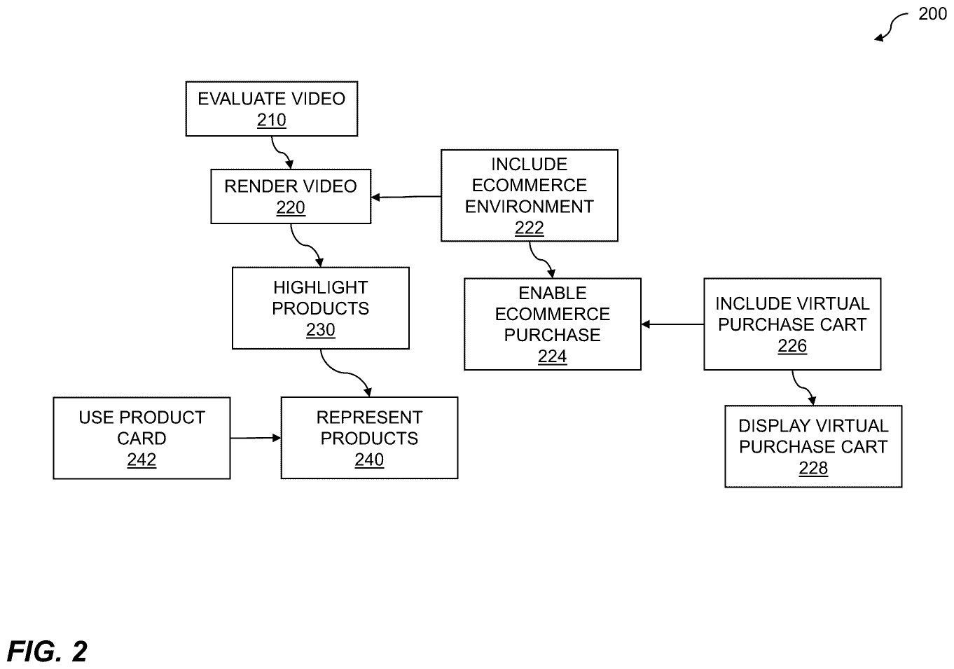

FIG. 2 is a flow diagram 200 for evaluating iterative AI prompt optimization in an ecommerce environment. The flow 200 includes evaluating the first short-form video 210, wherein the evaluating is based on one or more performance metrics. After the first text template is accessed and populated with parameter information from an ecommerce or other website, the first text template is submitted to an LLM/generative AI chatbot. The LLM/generative AI chatbot can use the first text template to generate a first video script, formatted in JavaScript Object Notation (JSON). The first video script is used to create a first short-form video, including all of the control parameters from the first text template and the populated entries from the ecommerce website. The host of the short-form video can be a human host who matches the control parameters, or a synthetic AI generated host. The synthetic AI generated host can be created by combining a human host performance with a 3D photorealistic image of a host that matches the control parameters contained in the first video script. In some embodiments, the AI machine learning model can also generate the voice of the first video host. The first video host voice can be a human voice or a synthesized voice that better matches the control parameters contained in the first video script. The control parameters can include information about the audience for the first short-form video, based on metadata stored on the ecommerce website about its users. In some embodiments, the metadata can include images of the ecommerce website users. Images of the users can be combined with demographic, economic, and geographic information collected from the ecommerce website and included in the first video script. These parameters can be used as input to an artificial intelligence (AI) machine learning model.

The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters included in the video script. In some embodiments, one or more products for sale can be included in the video script. The first short-form video can include highlighting the one or more products by the human or synthetic video host. After the first short-form video has been created, it can be evaluated 210, based on one or more performance metrics.

In embodiments, the performance metrics include an engagement metric, wherein the engagement metric comprises a sales goal and a number of views, and is based on metadata. The metadata includes hashtags, purchase history, repost velocity, view attributes, view history, ranking, or actions by one or more viewers. In embodiments, the evaluating includes a machine learning model. The AI machine learning model can be used to evaluate the first short-form video, based on the performance metrics. In later steps, the AI machine learning model can use the performance scores from the first short-form video to generate a second text template populated with control parameters updated by the AI machine learning model in order to improve the performance scores of the second short-form video.

The flow 200 includes rendering the first short-form video 220 that was created to one or more viewers, wherein the rendering includes an ecommerce environment 222. In embodiments, the evaluating of the first short-form video can be accomplished by rendering the video to a social media platform, an ecommerce website, etc., so that viewers can view the short-form video, as a standalone video or as part of a livestream event, and can then respond to the video. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. In embodiments, the rendering can include an ecommerce environment 222 that can enable ecommerce purchases 224. The ecommerce environment can include a virtual purchase cart 226 and product cards 242 that represent products for sale 240 as the short-form video host highlights products 230 in the video. The virtual purchase cart can be displayed while the short-form video plays as part of a livestream event, so that purchases can be made without the viewer leaving the website playing the short-form video. The evaluation of the short-form video can include numbers of sales, value of sales, length of viewing time, number of views of the short-form video, likes, chats, and so on, as well as metadata related to the viewers. The viewer metadata can include demographic information, purchase history, viewing history, and so on.

The flow 200 includes enabling an ecommerce purchase 224, within the ecommerce environment 222, of one or more products for sale. In embodiments, the enabling includes a virtual purchase cart 226. The short-form video rendering further comprises displaying, within the first short-form video that was rendered, the virtual purchase cart 228. The virtual purchase cart can cover a portion of the first short-form video. In embodiments, the evaluating comprises rendering, to one or more viewers, the first short-form video that was created, wherein the rendering includes an ecommerce environment. In some embodiments, the first short-form video can be used as a livestream hosted by the ecommerce website or a social media website. In embodiments, the first short-form video can include highlighting 230 one or more products for sale to the one or more viewers, representing the one or more products for sale 240 in an on-screen product card 242. A product card can be generated and rendered on the device for viewing the short-form video. In embodiments, the product card 242 represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase 224 by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

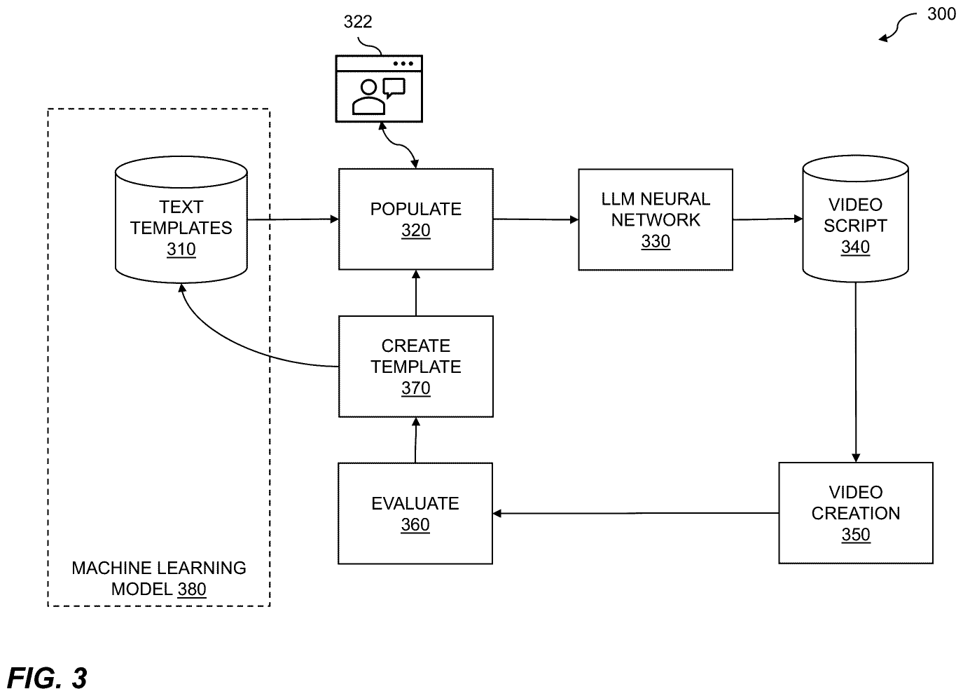

FIG. 3 is an infographic for iterative AI prompt optimization for video generation. The infographic 300 includes accessing a first text template 310, wherein the first text template is readable by a large language model (LLM) neural network 330, and wherein the first text template includes one or more control parameters. In embodiments, a first text template is created to be read by an LLM/generative AI chatbot such as ChatGPT and is prepared for input from a website. The text templates can be stored in a library of templates that can be used to generate short-form videos for various websites, viewer populations, sales campaigns, educational situations, and so on. The text template library can store control parameters that can be used with the text templates as needed to match requirements from websites requesting short-form videos. The control parameters can include a tone or feel of a short-form video to be generated, such as positive or negative, serious or lighthearted, etc.; a target audience; video host characteristics such as gender, age, appearance, and vocal quality; video environment settings and background images; products for sale; media instructions; and so on. The one or more media instructions can include one or more cameras, a camera exposure, f-stop settings, video format, camera angles, lighting, language, voice-over text, a number of images, and a number of short-form videos to be created. As the number of effective short-form videos increases, the most successful text templates can be stored in a database to be used with different combinations of products for sale, different audiences, and different host websites.

The infographic 300 includes populating the first text template 320, wherein the populating includes information from within a website 322. The information from the website can include one or more images, one or more videos, text to be used within the short-form video, and so on. The information can relate to products for sale; host images to be used; descriptions of products, ideas, or concepts being taught; demonstrations of products; illustrations of concepts; etc. The control parameters are taken from a website that is used for ecommerce and stores data relating to products for sale and customers that purchase goods and services. Metadata relating to the products for sale and to the customers can be included in the control parameter information and can be used to create a first short-form video 350. The first text template 310 contains code language that can be read by the LLM/generative AI chatbot, and placeholders for the information coming from the ecommerce website. The information from the ecommerce website 322 is used to populate the first text template by placing the matching information into the placeholders contained in the first text template. The populated first text template is thus prepared to be submitted to the AI chatbot.

The infographic 300 includes submitting a request, to the LLM/generative AI chatbot 330, wherein the request includes the first text template 310 that was populated 320. In embodiments, after the information from the ecommerce website 322 is used to populate 320 the first text template, the text template is fed into the LLM neural network/generative AI chatbot 330. The LLM/AI chatbot 330 must be told the type of code required and the desired outputs of the code. These parameters are included in the first text template 310. If requested, the chatbot will break down and explain the resulting code it generates. The largest AI chatbots have access to hundreds of code libraries and coding resources created by programmers across the globe. In embodiments, the LLM/generative AI chatbot draws from these code libraries to construct programs in response to the request that includes the first text template.

The infographic 300 includes generating, by the LLM neural network/generative AI chatbot, a first video script 340. In embodiments, the format of the first video script generated is JavaScript Object Notation (JSON). The AI chatbot request includes the JSON code format, as well as all of the first text template and control parameters from the ecommerce website. The response from the LLM/AI chatbot is a video script in JSON format that can be used to generate a short-form video. The video script 340 contains all of the control parameters and instructions necessary to generate the short-form video, including audio and video requirements, host information, product information, tone, number of short-form videos to be generated, and so on. The role of the LLM/generative AI chatbot is to translate the populated first text template into JSON code and write out a properly formatted video script using the JSON language.

The infographic 300 includes creating a first short-form video 350, wherein the first short-form video is based on the first video script 340 that was generated. In embodiments, a JSON formatted video script can be used to create a first short-form video, including all of the control parameters from the first text template and the populated entries from the ecommerce website. The host of the short-form video can be a human host who matches the control parameters, or a synthetic AI generated host. The synthetic AI generated host can be created by combining a human host performance with a 3D photorealistic image of a host that matches the control parameters contained in the first video script. In some embodiments, an AI machine learning model can also generate the voice of the first video host. The first video host voice can be a human voice, or a synthesized voice that better matches the control parameters contained in the first video script. The control parameters can include information about the audience for the first short-form video, based on metadata stored on the ecommerce website about its users. In some embodiments, the metadata can include images of the ecommerce website users. Images of the users can be combined with demographic, economic, and geographic information collected from the ecommerce website and included in the first video script. These parameters can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters included in the video script. In some embodiments, one or more products for sale can be included in the video script. The first short-form video can include highlighting the one or more products by the human or synthetic video host.

The infographic 300 includes evaluating the first short-form video 360, wherein the evaluating is based on one or more performance metrics. In embodiments, the evaluating comprises rendering, to one or more viewers, the first short-form video that was generated, wherein the rendering includes an ecommerce environment. The first short-form video includes highlighting one or more products for sale to the one or more viewers. In some embodiments, the first short-form video can be used as a livestream hosted by the ecommerce website or a social media website. The ecommerce environment includes enabling an ecommerce purchase, within the ecommerce environment, of one or more products for sale, wherein the ecommerce purchase includes a virtual purchase cart. The rendering further comprises displaying, within the first short-form video that was rendered, the virtual purchase cart, wherein the virtual purchase cart covers a portion of the first short-form video. The rendering further comprises representing one or more products for sale in an on-screen product card. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video.

In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

In embodiments, the evaluating is accomplished by the machine learning model 380. The one or more performance metrics include an engagement metric, which can include a number of product sales, a number of views, a number of host followers, time spent on the host website, user metadata, and so on. The user metadata can include hashtags, purchase history, repost velocity, view attributes, view history, ranking, and actions by one or more viewers. In later steps, the results of the evaluation can be used as input to the generative AI machine learning model in order to create a second text template 370.

The infographic 300 includes training a machine learning model 380, wherein the training data includes the first text template 310 that was populated 320, the first short-form video that was created 350, the information from within a website 322, and the evaluating 360. In embodiments, the training of the machine learning model is accomplished using a genetic algorithm. A genetic algorithm is an adaptive heuristic search algorithm that can be used to generate high-quality sets of options for solving optimization questions, such as finding the best set of control parameters to use in a video script in order to produce the most effective short-form video for engagement and product sales. In embodiments, a heuristic algorithm is used to generate solutions that are good enough to move forward in a reasonable frame of time. They are essentially best guesses based on the available data that can be created quickly and used to create the next iteration of parameters for a generative AI model. The generative AI model can be trained with all the available information from the first iteration of short-form video generation, including the first text template, the data from the ecommerce website used to populate the template, the first short-form video, and the evaluation results. The results of the evaluation 360 can be used by the AI machine learning model 380 to generate a varied set of control parameters for the next iteration of text template 370 to be used.

The infographic 300 includes iteratively creating a second text template, wherein the creating is accomplished by the machine learning model based on the one or more performance metrics. In embodiments, the machine learning model creates the second text template based on the engagement and performance metric evaluations of the first short-form video. The machine learning model can update one or more control parameters from the first text template 310 and the website 322, comprising removing a control parameter, adding a new control parameter, changing a control parameter, and including one or more natural language (NLP) instructions in creating the second text template. The natural language (NLP) instruction can be used to change control parameters used in the second text template, such as modifying or expanding the spoken text of the video host, updating printed descriptions used in the next short-form video, etc. In some embodiments, the NLP instruction can modify the second text template directly, so that the video script created by the LLM/generative AI chatbot is updated and improved. After the second text template is created, it is populated by the machine learning model. After being populated, the second text template is included in a request to the LLM/generative AI chatbot to produce a second video script. The format of the second video script that was generated is JavaScript Object Notation (JSON). The second video script is used to produce a second short-form video. The second short-form video can be rendered to one or more viewers. The rendering can include an ecommerce environment. The rendered second short-form video can be evaluated by the machine learning model using the same criteria used for the first short-form video. The results of the performance metrics evaluation of the second short-form video can be combined with the populated second text template and the second short-form video to update the training data of the machine learning model. The updated machine learning model can then be used to create a third text template, which can be adjusted and populated by the updated machine learning model, and so on. The iterative cycle of text template, video script, video creation, video rendering, and evaluating can continue until one or more short-form videos that meet the performance standards required by the ecommerce website or other website operators are generated.

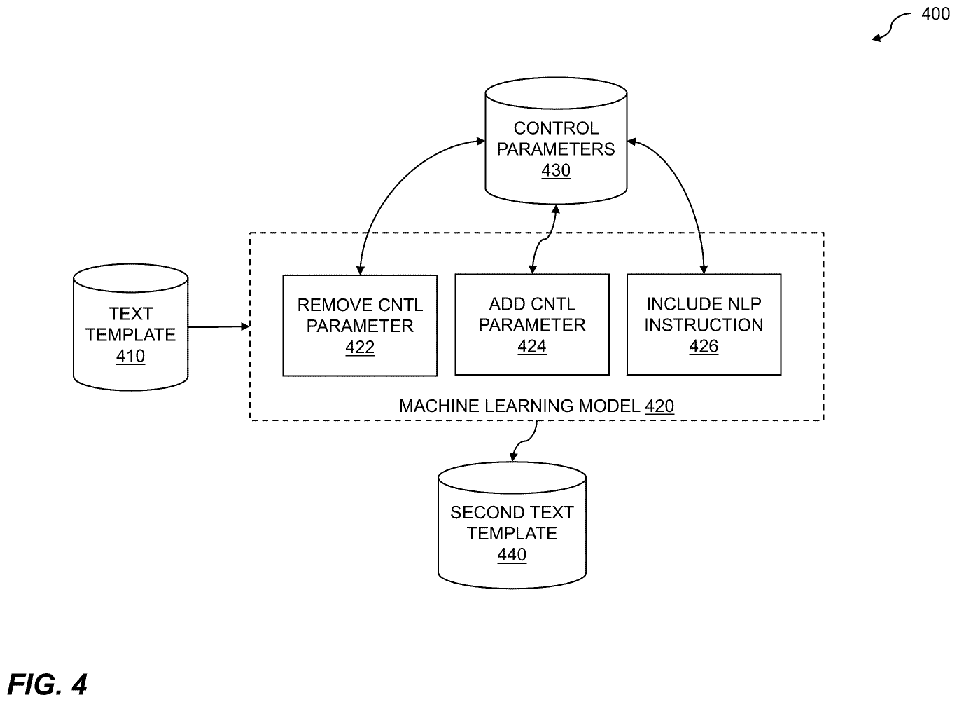

FIG. 4 is an infographic for updating a text template. The infographic 400 includes accessing a first text template 410, wherein the first text template is readable by a large language model (LLM) neural network, and wherein the first text template includes one or more control parameters 430. The infographic 400 includes populating the first text template, wherein the populating includes information from within a website. After the first text template 410 is accessed and populated with parameter information from a website, the first text template is submitted to an LLM/generative AI chatbot. The LLM/generative AI chatbot can use the first text template to generate a first video script, formatted in JavaScript Object Notation (JSON). The first video script is used to create a first short-form video, including the control parameters 430 from the first text template 410 and the populated entries from the website. The host of the short-form video can be a human host who matches the control parameters 430, or a synthetic AI generated host. The synthetic AI generated host can be created by combining a human host performance with a 3D photorealistic image of a host that matches the control parameters contained in the first video script. In some embodiments, the AI machine learning model can also generate the voice of the first video host. The first video host voice can be a human voice or a synthesized voice that matches the control parameters 430 contained in the first video script. The control parameters can include information about the audience for the first short-form video, based on metadata stored on the website about its users. In some embodiments, the metadata can include images of the website users.

Images of the users can be combined with demographic, economic, and geographic information collected from the website and included in the first video script. These parameters can be used as input to an artificial intelligence (AI) machine learning model. The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters 430 included in the video script. For example, the synthetic host can represent an educator that the student viewers view as engaging and knowledgeable. Or the synthetic host can look and sound like an attractive and encouraging personality that is similar to a group of viewers watching a livestream demonstrating personal care products. In embodiments, one or more products for sale can be included in the video script. The first short-form video can include highlighting the one or more products by the human or synthetic video host. After the first short-form video has been created, it can be evaluated, based on one or more performance metrics.

In embodiments, the performance metrics include an engagement metric. The engagement metric can include sales goals, the number of short-form video views, number of likes, length of engagement, and so on. The engagement metrics can use website and viewer metadata. The metadata can include hashtags, purchase history, repost velocity, view attributes, view history, ranking, or actions by one or more viewers. In embodiments, the AI machine learning model can evaluate the first short-form video, based on the performance metrics. In later steps, the AI machine learning model can use the performance scores from the first short-form video to generate a second text template populated with control parameters updated by the AI machine learning model in order to improve the performance scores of the second short-form video.

The infographic 400 includes training a machine learning model 420, wherein the training data includes the first text template that was populated, the first short-form video that was created, the information from within a website, and the evaluating of the first short-form video. In embodiments, the training of the machine learning model is accomplished using a genetic algorithm. A genetic algorithm is an adaptive heuristic search algorithm that can be used to generate high-quality sets of options for solving optimization questions, such as finding the best set of control parameters to use in a video script in order to produce the most effective short-form video for engagement and product sales. In embodiments, a heuristic algorithm is used to generate solutions that are good enough to move forward in a reasonable frame of time. They are essentially best guesses based on the available data that can be created quickly and used to create the next iteration of parameters for a generative AI model. The generative AI model can be trained with all the available information from the first iteration of short-form video generation, including the first text template, the data from the ecommerce website used to populate the template, the first short-form video, and the evaluation results. In later steps, additional iterations of the text template, data from the website used to populate the template, changes to the control parameters generated by the AI machine learning model, the short-form video, and the evaluation results can all be added to the training data for the machine learning model. As each iteration cycle completes, the AI machine learning model gains additional training data that can be used to refine and improve the text template, control parameters, and website data used in the next short-form video cycle. Thus, each short-form video produced can become more effective in engaging the target audience and marketing products.

The infographic 400 includes creating a second text template 440 based on the one or more performance metrics. In embodiments, the creating the second text template is accomplished by the machine learning model. After evaluating the performance of the first short-form video, the generative AI machine learning model can be used to generate a new set of control parameters for the second text template 440. The creating the second text template can be accomplished by the machine learning model 420 by removing a control parameter 422 from the one or more control parameters; by adding a new control parameter 424; and by including at least one natural language instruction 426. For example, the first text template 410 could select a male, middle-age, Caucasian as the presenter host in the first short-form video. After the performance metrics of the first short-form video are evaluated by the machine learning model, the model can change the control parameters for the second text template by removing 422 the male and Caucasian parameters and adding 424 female and Latina parameters for the presenter host of the second short-form video. The natural language (NLP) instruction can be used to change control parameters used in the second text template 440, such as modifying or expanding the spoken text of the video host, updating printed descriptions used in the next short-form video, etc. In some embodiments, the NLP instruction can modify the second text template directly, so that the video script created by the LLM/generative AI chatbot is updated and improved. After the second text template is created, it is populated by the machine learning model with the updated control parameters, NLP instructions, and information from the website. After being populated, the second text template can be included in a request to the LLM/generative AI chatbot to produce a second video script. The second video script can then be used to produce a second short-form video.

The second short-form video can be rendered to one or more viewers. The rendering can include an ecommerce environment. The rendered second short-form video can be evaluated by the machine learning model 420 using the same criteria used for the first short-form video. In embodiments, the results of the performance metrics evaluation of the second short-form video can be combined with the populated second text template and the second short-form video to update the training data of the machine learning model. The updated machine learning model can then be used to create a third text template, which can be adjusted and populated by the machine learning model 420, and so on. The iterative cycle of text template, video script, video creation, video rendering, and evaluating can continue until one or more short-form videos are generated that meet the performance standards required by the ecommerce website or other website operators.

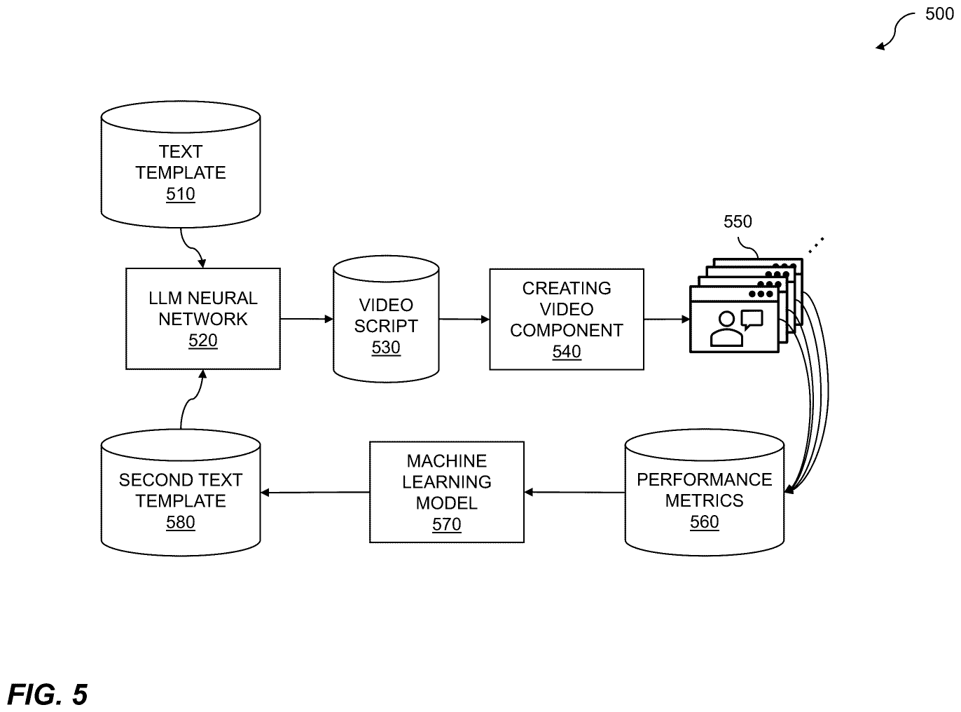

FIG. 5 is an infographic for evaluating a text template. The infographic 500 includes accessing a first text template 510, wherein the first text template is readable by a large language model (LLM) neural network 520, and wherein the first text template includes one or more control parameters. In embodiments, the control parameters can include a tone or feel of a short-form video to be generated, such as positive or negative, serious or lighthearted, etc.; a target audience; video host characteristics such as gender, age, appearance, and vocal quality; video environment settings and background images; products for sale; media instructions; and so on. The one or more media instructions can include one or more cameras, a camera exposure, f-stop settings, video format, camera angles, lighting, language, voice-over text, a number of images, and a number of short-form videos to be created. In some embodiments, the one or more control parameters can be obtained from a library of templates. As the number of effective short-form videos increases, the most successful text templates can be stored in a database to be used with different combinations of products for sale, different audiences, and different host websites.

The infographic 500 includes populating the first text template 510, wherein the populating includes information from within a website. In embodiments, the information from within a website can include one or more images, one or more videos, and text. In some embodiments, control parameters can be taken from a website that is used for ecommerce and can store data relating to products for sale and customers that purchase goods and services. Metadata relating to the products for sale and to the customers can be included in the control parameter information and can be used to create a first short-form video. The first text template 510 contains code language that can be read by the LLM neural network 520 and placeholders for the information coming from the ecommerce website. The information from the website is used to populate the first text template 510 by placing the matching information into the placeholders contained in the first text template. The populated first text template is thus prepared to be submitted to the LLM neural network. In some embodiments, the LLM neural network is a generative artificial intelligence (AI) chatbot.

A request can be submitted to the LLM neural network/generative AI chatbot. The request can include the first text template 510 that was populated from the website. The first text template must specify a computer language code in the control parameters submitted to the LLM/generative AI chatbot, as well as the desired outputs of the code, so that the chatbot response can be used in subsequent flow steps. These parameters are included in the first text template. If requested, the chatbot will break down and explain the resulting code it generates. The largest AI chatbots have access to hundreds of code libraries and coding resources created by programmers across the globe. In embodiments, the LLM/generative AI chatbot draws from these code libraries to construct programs in response to the request that includes the first text template.

The infographic 500 includes generating, by the LLM/generative AI chatbot, a first video script 530. In embodiments, the format of the first video script generated is JavaScript Object Notation (JSON). The LLM neural network/AI chatbot request 520 includes the JSON code format, as well as all of the first text template and control parameters from the ecommerce website. The response from the AI chatbot is a video script in JSON format that can be used to generate one or more short-form videos. The video script contains all of the control parameters and instructions necessary to generate the short-form video, including audio and video requirements, host information, product information, tone, number of short-form videos to be generated, and so on. The role of the LLM/generative AI chatbot is to translate the first text template 510 into JSON code and write out a formatted video script using the JSON computer language.

The infographic 500 includes creating a first short-form video 540, wherein the first short-form video 540 is based on the first video script 530 that was generated. In embodiments, the JSON formatted video script can be used to create a first short-form video, including all of the control parameters from the first text template and the populated entries from the website. The host of the short-form video can be a human host who matches the control parameters, or a synthetic AI generated host. The synthetic AI generated host can be created by combining a human host performance with a 3D photorealistic image of a host that matches the control parameters contained in the first video script. In some embodiments, the AI machine learning model can also generate the voice of the first video host. The first video host voice can be a human voice or a synthesized voice that better matches the control parameters contained in the first video script. The control parameters can include information about the audience for the first short-form video, based on metadata stored on the ecommerce website about its users. In some embodiments, the metadata can include images of the ecommerce website users. Images of the users can be combined with demographic, economic, and geographic information collected from the ecommerce website and included in the first video script. These parameters can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters included in the video script. In some embodiments, one or more products for sale can be included in the video script. The first short-form video can include highlighting the one or more products by the human or synthetic video host.

The infographic 500 includes rendering 550, to one or more viewers, the first short-form video that was created 540, wherein the rendering includes an ecommerce environment. In embodiments, the evaluating of the first short-form video can be accomplished by rendering the video 550 to a social media platform, an ecommerce website, etc., so that viewers can view the short-form video as a standalone video or as part of a livestream event, and can respond to the video. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. In embodiments, the rendering can include an ecommerce environment that can enable ecommerce purchases. The ecommerce environment can include a virtual purchase cart and product cards that represent products for sale as the short-form video host highlights products in the video. The virtual purchase cart can be displayed while the short-form video plays as part of a livestream event so that purchases can be made without the viewer leaving the website playing the short-form video.

The infographic 500 includes evaluating the first short-form video, wherein the evaluating is based on one or more performance metrics 560. In embodiments, the performance metrics include an engagement metric, which can include sales goals, number of views, number of viewers, length of time on the site, length of video viewing time, number of products sold, value of products sold, viewer metadata and so on. The metadata can include hashtags, purchase history, repost velocity, view attributes, view history, ranking, or actions by one or more viewers. Education-oriented websites can include the number of classes for which a viewer is enrolled, number of classes completed, number of lectures viewed, test scores, papers submitted, and so on. Websites with livestream demonstrations can look for numbers of products purchased after viewing, numbers of multiple views by the same viewer, sections of the livestream demonstration reviewed, and so on. The performance metrics can be tailored to the related website, to a particular viewer audience, to a specific year in school, etc.

In embodiments, the evaluating includes a machine learning model. In the infographic 500, the AI machine learning model 570 can be used to evaluate the first short-form video that was rendered 550, based on the performance metrics. The machine learning model 570 is trained, wherein the training data includes the first text template that was populated 510, the first short-form video that was created 540, the information from within a website, and the evaluating of the first short-form video. In embodiments, the training of the machine learning model is accomplished using a genetic algorithm. A genetic algorithm is an adaptive heuristic search algorithm that can be used to generate high-quality sets of options for solving optimization questions, such as finding the best set of control parameters to use in a video script in order to produce the most effective short-form video for engagement and product sales. In embodiments, a heuristic algorithm is used to generate solutions that are good enough to move forward in a reasonable time frame. They are essentially best guesses based on the available data that can be created quickly and used to create the next iteration of parameters for a generative AI model. The generative AI model can be trained with all the available information from the first iteration of short-form video generation, including the first text template 510, the data from the website used to populate the template, the control parameters to create the first short-form video, the first short-form video itself, and the performance metric 560 evaluation results.

As the AI machine learning model takes in the training data, it can be used to generate a new set of control parameters and NLP statements to generate a new text template. The purpose of the new text template is to generate a new short-form video that receives improved performance metric scores, and therefore engages the viewers more fully and elicits greater sales in cases where products are being demonstrated or offered as part of the short-form video. In embodiments, the creating the second text template is accomplished by the machine learning model. After evaluating the performance of the first short-form video, the generative AI machine learning model 570 can be used to generate a new set of control parameters for the new, second text template 580. The creating the second text template can be accomplished by the machine learning model by removing a control parameter from the one or more control parameters; by adding a new control parameter; and by including at least one natural language instruction. For example, the first text template 510 could select a male, middle-aged, Caucasian as the presenter host in the first short-form video. After the performance metrics of the first short-form video are evaluated by the machine learning model, the model can change the control parameters for the second text template 580 by removing the male and Caucasian parameters and adding female and Latina parameters for the presenter host of the second short-form video. The natural language (NLP) instruction can be used to change control parameters used in the second text template, such as modifying or expanding the spoken text of the video host, updating printed descriptions used in the next short-form video, etc. In some embodiments, the NLP instruction can modify the second text template directly, so that the video script created by the LLM/generative AI chatbot is updated and improved. After the second text template is created, it is populated by the machine learning model with the updated control parameters, NLP instructions, and information from the website. After being populated, the second text template can be included in a request to the LLM/generative AI chatbot to produce a second video script.

The second video script can then be used to produce a second short-form video. The second short-form video can be rendered to one or more viewers 550. The rendering can include an ecommerce environment. The rendered second short-form video can be evaluated by the machine learning model 570 using the performance metrics 560 used for the first short-form video. The results of the performance metrics evaluation of the second short-form video can be combined with the populated second text template and the second short-form video to update the training data of the machine learning model 126 referenced in FIG. 1. The updated machine learning model can then be used to create a third text template, which can be adjusted and populated by the machine learning model 570, and so on. The iterative cycle of text template, video script, video creation, video rendering, and evaluating can continue until one or more short-form videos are generated that meet the performance standards required by the website operators.

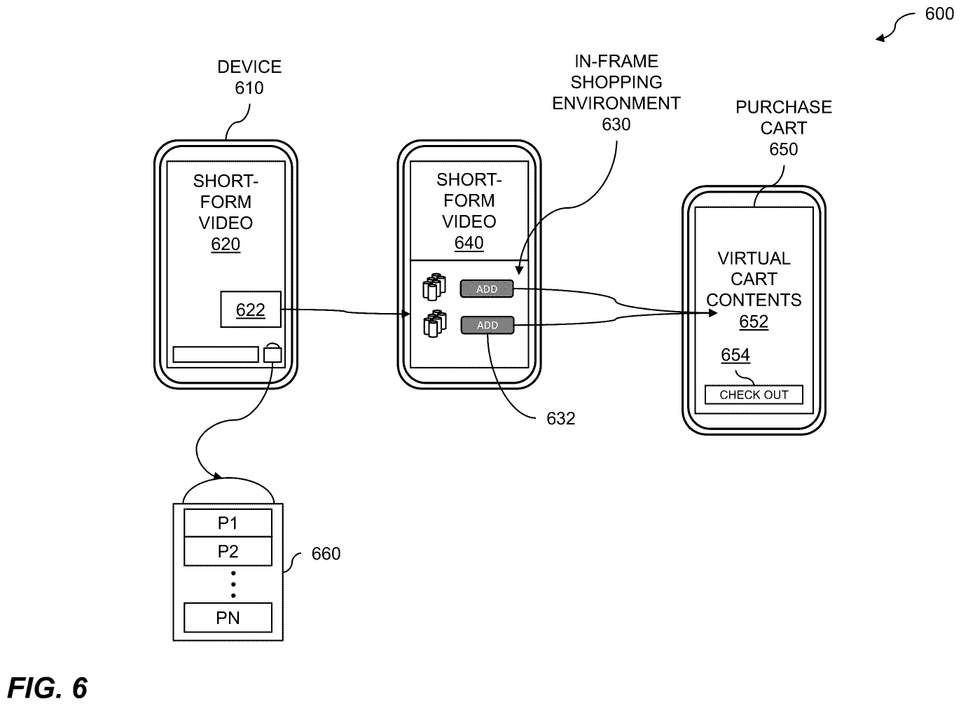

FIG. 6 illustrates an ecommerce purchase. The ecommerce purchase can be enabled by iterative AI prompt optimization for video generation. As described above and throughout, a first text template to be read by a large language model (LLM) neural network is accessed. The template includes control parameters that are populated from within a website. The populated template is submitted as a request to the LLM neural network, which generates a first video script. The first video script is used to create a first short-form video. The first short-form video is evaluated based on one or more performance metrics. The text template, short-form video, website information, and evaluation are used to train a machine learning model that is used to create a second text template. The second text template can be used to generate a second short-form video. The evaluation of iterative text templates and resulting short-form videos continues until a usable video is produced.

The illustration 600 includes a device 610 displaying a short-form video 620 as part of a livestream event. In embodiments, the livestream can be viewed in real time or replayed at a later time. The device 610 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream on the device can be accomplished using a browser or another application running on the device.

The illustration 600 includes generating and revealing a product card 622 on the device 610. In embodiments, the product card represents at least one product available for purchase while the livestream short-form video plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card 622 can be inserted when the livestream is visible in the livestream event short-form video 640. When the product card is invoked, an in-frame shopping environment 630 is rendered over a portion of the video while the video continues to play. This rendering enables an ecommerce purchase 632 by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 600 includes rendering an in-frame shopping environment 630 enabling a purchase of the at least one product for sale by the viewer, wherein the ecommerce purchase is accomplished within the livestream event short-form video window 640. In embodiments, the livestream event can include the livestream and/or a prerecorded video segment. The enabling can include revealing a virtual purchase cart 650 that supports checkout 654 of virtual cart contents 652, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 660 are purchased via product cards during the livestream event, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

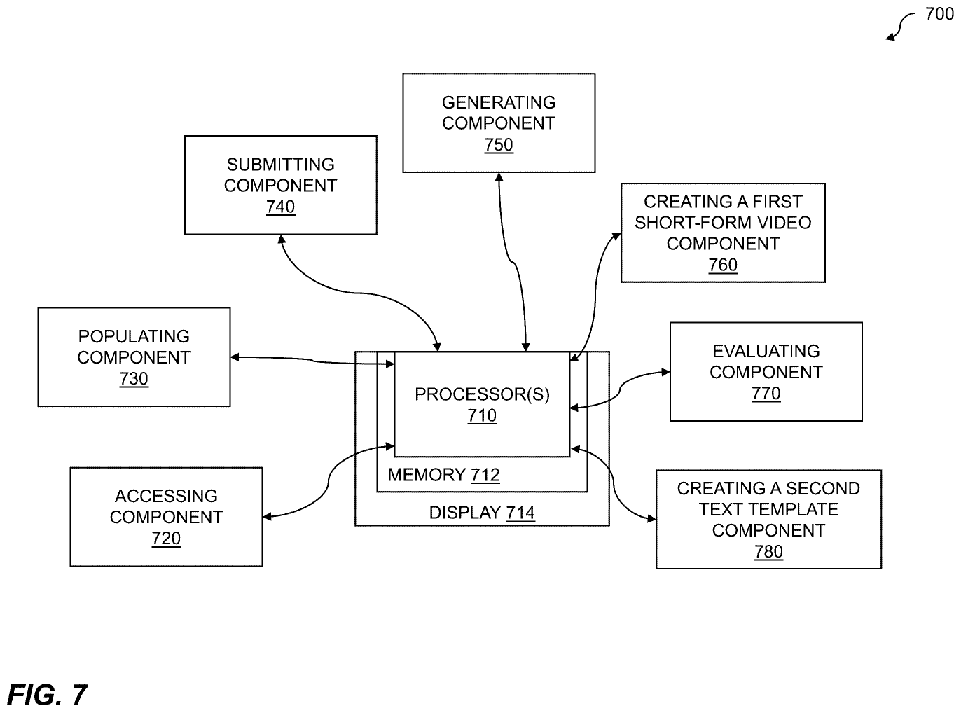

FIG. 7 is a system diagram for iterative AI prompt optimization for video generation. The system 700 can include one or more processors 710 coupled to a memory 712 which stores instructions. The system 700 can include a display 714 coupled to the one or more processors 710 for displaying data, video streams, videos, intermediate steps, instructions, and so on. In embodiments, one or more processors 710 are coupled to the memory 712 where the one or more processors, when executing the instructions which are stored, are configured to: access a first text template, wherein the first text template is readable by a large language model (LLM) neural network, and wherein the first text template includes one or more control parameters; populate the first text template, wherein the populating includes information from within a website; submit a request, to the LLM, wherein the request includes the first text template that was populated; generate, by the LLM, a first video script; create a first short-form video, wherein the first short-form video is based on the first video script that was generated; evaluate the first short-form video, wherein the evaluating is based on one or more performance metrics; and create a second text template based on the one or more performance metrics.

The system 700 includes an accessing component 720. The accessing component 720 can include functions and instructions for accessing a first text template, wherein the first text template is readable by a large language model (LLM) neural network, and wherein the first text template includes one or more control parameters. The LLM neural network can be comprised of a generative artificial intelligence (AI) chatbot. In embodiments, the control parameters can include a tone or feel of a short-form video to be generated, such as positive or negative, serious or lighthearted, etc.; a target audience; video host characteristics such as gender, age, appearance, and vocal quality; video environment settings and background images; products for sale; media instructions; and so on. The one or more media instructions can include one or more cameras, a camera exposure, f-stop settings, video format, camera angles, lighting, language, voice-over text, a number of images, and a number of short-form videos to be created. The one or more control parameters is obtained from a library of templates. As the number of effective short-form videos increases, the most successful text templates can be stored in a library to be used with different combinations of products for sale, different audiences, and different host websites.

The system 700 includes a populating component 730. The populating component 730 can include functions and instructions for populating the first text template, wherein the populating includes information from within a website. The information from within a website can include one or more images, one or more videos, and text. The text can include product names and descriptions, text to be included in a voice-over or video host dialogue, and so on. In embodiments, the information from within a website can include one or more images, one or more videos, and text. The control parameters are taken from a website that is used for ecommerce and stores data relating to products for sale and customers that purchase goods and services. Metadata relating to the products for sale and to the customers can be included in the control parameter information and can be used to create a first short-form video. The first text template contains code language that can be read by the LLM/generative AI chatbot and placeholders for the information coming from the ecommerce website. The information from the ecommerce website is used to populate the first text template by placing the matching information into the placeholders contained in the first text template. The populated first text template is thus prepared to be submitted to the LLM neural network/generative AI chatbot.

The system 700 includes a submitting component 740. The submitting component 740 can include functions and instructions for submitting a request, to the LLM neural network, wherein the request includes the first text template that was populated. In embodiments, after the information from the ecommerce website is used to populate the first text template, the text template is fed into the LLM/generative AI chatbot. The AI chatbot must be told the type of code required and the desired outputs of the code. These parameters are included in the first text template. If requested, the chatbot will break down and explain the resulting code it generates. The largest AI chatbots have access to hundreds of code libraries and coding resources created by programmers across the globe. In embodiments, the LLM/generative AI chatbot draws from these code libraries to construct programs in response to the request that includes the first text template.

The system 700 includes a generating component 750. The generating component 750 can include functions and instructions for generating, by the LLM neural network, a first video script, wherein a format of the first video script that was generated is JavaScript Object Notation (JSON). The flow includes generating, by the LLM/generative AI chatbot, a first video script. In embodiments, the format of the first video script generated is JavaScript Object Notation (JSON). The AI chatbot request includes the JSON code format, as well as all of the first text template and control parameters from the ecommerce website. The response from the AI chatbot is a video script in JSON format that can be used to generate a short-form video. The video script contains all of the control parameters and instructions necessary to generate the short-form video, including audio and video requirements, host information, product information, tone, number of short-form videos to be generated, and so on. The role of the LLM/generative AI chatbot is to translate the first text template into JSON code and write out a properly formatted video script using the JSON language.

The system 700 includes a creating a first short-form video component 760. The creating a first short-form video component 760 can include functions and instructions for creating a first short-form video, wherein the first short-form video is based on the first video script that was generated. In embodiments, the JSON formatted video script can be used to create a first short-form video, including all of the control parameters from the first text template and the populated entries from the ecommerce website. The host of the short-form video can be a human host who matches the control parameters, or a synthetic AI generated host. The synthetic AI generated host can be created by combining a human host performance with a 3D photorealistic image of a host that matches the control parameters contained in the first video script. In some embodiments, the AI machine learning model can also generate the voice of the first video host. The first video host voice can be a human voice or a synthesized voice that better matches the control parameters contained in the first video script. The control parameters can include information about the audience for the first short-form video, based on metadata stored on the ecommerce website about its users. In some embodiments, the metadata can include images of the ecommerce website users. Images of the users can be combined with demographic, economic, and geographic information collected from the ecommerce website and included in the first video script. These parameters can be used as input to an artificial intelligence (AI) machine learning model. In embodiments, an AI machine learning model can be trained to recognize ethnicity, sex, and age. The AI machine learning model can access a library of images of individuals that can be used as synthetic hosts. The library of images can include options of ethnicity, sex, age, hair color and style, clothing, accessories, etc. Information related to each host image can be stored as metadata with each image. Aspects of the individual can include clothing, accessories, facial expressions, gestures, and so on. The aspects of the individual can be isolated and altered, swapped, or deleted as needed in order to customize the appearance of the image to be used as a synthetic host. The customizations can be used to create the best match of the synthetic host to the control parameters included in the video script. In some embodiments, one or more products for sale can be included in the video script. The first short-form video can include highlighting the one or more products by the human or synthetic video host.

The system 700 includes an evaluating component 770. The evaluating component 770 can include functions and instructions for evaluating the first short-form video, wherein the evaluating is based on one or more performance metrics. In embodiments, the evaluating includes training a machine learning model, wherein the training data includes the first text template that was populated, the first short-form video that was created, the information from within a website, and the evaluating data. The training is accomplished using a genetic algorithm. A genetic algorithm is an adaptive heuristic search algorithm that can be used to generate high-quality sets of options for solving optimization questions, such as finding the best set of control parameters to use in a video script in order to produce the most effective short-form video for engagement and product sales. In embodiments, a heuristic algorithm is used to generate solutions that are good enough to move forward in a reasonable time frame. They are essentially best guesses based on the available data that can be created quickly and used to create the next iteration of parameters for a generative AI model. The generative AI model can be trained with all the available information from the first iteration of short-form video generation, including the first text template, the data from the ecommerce website used to populate the template, the first short-form video, and the evaluation results.

The evaluating the short-form video is accomplished by the machine learning model. The evaluating is based on one or more performance metrics. The one or more performance metrics can include an engagement metric, which can include sales goals, number of views, number of viewers, length of time on the site, length of video viewing time, number of products sold, value of products sold, viewer metadata and so on. The metadata can include hashtags, purchase history, repost velocity, view attributes, view history, ranking, or actions by one or more viewers. Education-oriented websites can include the number of classes for which a viewer is enrolled classes, number of classes completed, number of lectures viewed, test scores, papers submitted, and so on. Websites with livestream demonstrations can look for numbers of products purchased after viewing, numbers of multiple views by the same viewer, sections of the livestream demonstration reviewed, and so on. The performance metrics can be tailored to the related website, to a particular viewer audience, to a specific year in school, etc.

The evaluating further comprises rendering, to one or more viewers, the first short-form video that was created, wherein the rendering includes an ecommerce environment. The first short-form video includes highlighting the one or more products for sale to one or more viewers, and representing the one or more products for sale in an on-screen product card. The rendering further comprises enabling an ecommerce purchase, within the ecommerce environment, of one or more products for sale, wherein the ecommerce purchase includes a virtual purchase cart. The rendering further comprises displaying, within the first short-form video that was rendered, the virtual purchase cart, wherein the virtual purchase cart covers a portion of the first short-form video. In some embodiments, the first short-form video can be used as a livestream hosted by the ecommerce website or a social media website. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video. In embodiments, the product card represents at least one product available for purchase on the website or social media platform hosting the short-form video, or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video.

The product card is selectable via a user interface action such as a press, swipe, gesture, mouse click, verbal utterance, or some other suitable user action. When the product card is invoked, an in-frame shopping environment can be rendered over a portion of the short-form video while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The system 700 includes a creating a second text template component 780. The creating a second text template component 780 can include functions and instructions for creating a second text template based on the one or more performance metrics. In embodiments, the one or more performance metrics include an engagement metric, wherein the engagement metric is used to update one or more control parameters within the text template. The one or more control parameters are obtained from a library of templates. In embodiments, the creating a second text template is accomplished by the machine learning model. The machine learning model can remove a control parameter from the one or more control parameters, can add one or more new control parameters, and can include at least one natural language (NLP) instruction. The populating of the second text template is accomplished by the machine learning model. The populated second text template is submitted to the LLM neural network/generative AI chatbot, a second audio script is generated by the LLM neural network/generative AI chatbot, and a second short-form video is generated, rendered, and evaluated. The natural language (NLP) instruction can be used to change control parameters used in the second text template, such as modifying or expanding the spoken text of the video host, updating printed descriptions used in the next short-form video, etc.

In some embodiments, the NLP instruction can modify the second text template directly, so that the video script created by the LLM/generative AI chatbot is updated and improved. After the second text template is created, it is populated by the machine learning model. After being populated, the second text template is submitted in a request to the LLM/generative AI chatbot to generate a second video script. The format of the second video script that was generated is JavaScript Object Notation (JSON). The second video script is used to create a second short-form video. The second short-form video can be rendered to one or more viewers. The rendering can include an ecommerce environment. The rendered second short-form video can be evaluated by the machine learning model using the same criteria used for the first short-form video. The results of the performance metrics evaluation of the second short-form video can be combined with the populated second text template and the second short-form video to update the training data of the machine learning model. The updated machine learning model can then be used to create a third text template, which can be adjusted and populated by the machine learning model, and so on. The iterative cycle of text template, video script, video creation, video rendering, and evaluating can continue until one or more short-form videos are generated that meet the performance standards required by the ecommerce website or other website operators.

The system 700 can include a computer program product embodied in a non-transitory computer readable medium for video editing, the computer program product comprising code which causes one or more processors to perform operations of: accessing a first text template, wherein the first text template is readable by a large language model (LLM) neural network, and wherein the first text template includes one or more control parameters; populating the first text template, wherein the populating includes information from within a website; submitting a request, to the LLM neural network, wherein the request includes the first text template that was populated; generating, by the LLM neural network, a first video script; creating a first short-form video, wherein the first short-form video is based on the first video script that was generated; evaluating the first short-form video, wherein the evaluating is based on one or more performance metrics; and creating a second text template based on the one or more performance metrics.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video editing comprising:
accessing a first text template, wherein the first text template is readable by a large language model (LLM) neural network, and wherein the first text template includes one or more control parameters;
populating the first text template, wherein the populating includes information from within a website;
submitting a request, to the LLM neural network, wherein the request includes the first text template that was populated;
generating, by the LLM neural network, a first video script;
creating a first short-form video, wherein the first short-form video is based on the first video script that was generated;
evaluating the first short-form video, wherein the evaluating is based on one or more performance metrics; and
creating a second text template based on the one or more performance metrics.

2. The method of claim 1 further comprising training a machine learning model, wherein the training data includes the first text template that was populated, the first short-form video that was created, the information from within the website, and the evaluating.

3. The method of claim 2 wherein the creating of the second text template is accomplished by the machine learning model.

4. The method of claim 3 further comprising removing, by the machine learning model, a control parameter from the one or more control parameters.

5. The method of claim 3 further comprising adding, by the machine learning model, a new control parameter.

6. The method of claim 3 further comprising including, by the machine learning model, at least one natural language instruction.

7. The method of claim 3 wherein the populating includes the second text template, and wherein the populating is accomplished by the machine learning model.

8. The method of claim 7 wherein the generating further comprises producing a second video script.

9. The method of claim 8 wherein the creating further comprises producing a second short-form video.

10. The method of claim 9 wherein the evaluating includes the second short-form video.

11. The method of claim 10 wherein the evaluating is accomplished by the machine learning model.

12. The method of claim 10 wherein the training data includes the second text template that was populated, the second short-form video that was created, and the one or more performance metrics.

13. The method of claim 12 wherein the creating includes a third text template.

14. The method of claim 2 wherein the training is accomplished using a genetic algorithm.

15. The method of claim 1 wherein the one or more control parameters include a tone.

16. The method of claim 1 wherein the one or more control parameters include a target audience.

17. The method of claim 1 wherein the one or more control parameters include one or more media instructions.

18. The method of claim 17 wherein the one or more media instructions include a camera, an exposure, or a f-stop.

19. The method of claim 17 wherein the one or more media instructions include a voice-over.

20. The method of claim 17 wherein the one or more media instructions include a number of images.

21. The method of claim 1 wherein the evaluating further comprises rendering, to one or more viewers, the first short-form video that was created, wherein the rendering includes an ecommerce environment.

22. The method of claim 21 wherein the one or more performance metrics include an engagement metric.

23. The method of claim 22 wherein the engagement metric is used to update the one or more control parameters within the first text template.

24. The method of claim 23 wherein the one or more control parameters are obtained from a library of templates.

25. A computer program product embodied in a non-transitory computer readable medium for video editing, the computer program product comprising code which causes one or more processors to perform operations of:
accessing a first text template, wherein the first text template is readable by a large language model (LLM) neural network, and wherein the first text template includes one or more control parameters;
populating the first text template, wherein the populating includes information from within a website;
submitting a request, to the LLM neural network, wherein the request includes the first text template that was populated;
generating, by the LLM neural network, a first video script;
creating a first short-form video, wherein the first short-form video is based on the first video script that was generated;
evaluating the first short-form video, wherein the evaluating is based on one or more performance metrics; and
creating a second text template based on the one or more performance metrics.

26. A computer system for video editing comprising:
a memory which stores instructions;
one or more processors coupled to the memory wherein the one or more processors, when executing the instructions which are stored, are configured to:
access a first text template, wherein the first text template is readable by a large language model (LLM) neural network, and wherein the first text template includes one or more control parameters;
populate the first text template, wherein populating includes information from within a website;
submit a request, to the LLM neural network, wherein the request includes the first text template that was populated;
generate, by the LLM neural network, a first video script;
create a first short-form video, wherein the first short-form video is based on the first video script that was generated;
evaluate the first short-form video, wherein evaluating is based on one or more performance metrics; and
create a second text template based on the one or more performance metrics.
